(19) United States
(12) Patent Application Publication
(10) Pub. No.: US 2009/0310063 A1
(43) Pub. Date: Dec. 17, 2009

(54) METHOD OF DRIVING A LIGHT SOURCE, BACKLIGHT ASSEMBLY FOR PERFORMING THE METHOD AND DISPLAY APPARATUS HAVING THE BACKLIGHT ASSEMBLY

(76) Inventors: Ju-Young YOON, Seoul (KR); Ho-Sik Shin, Anyang-si (KR); Eun-Jeong Kang, Cheonan-si (KR); Seok-Won Kang, Gwangju-si (KR); Hee-Kwang Song, Anyang-si (KR)

Correspondence Address: Haynes and Boone, LLP;IP Section, 2323 Victory Avenue, SUITE 700, Dallas, TX, 75219, US

(21) Appl. No.: 12/484,041

(22) Filed: Jun. 12, 2009

(30) Foreign Application Priority Data
Jun. 17, 2008 (KR) 2008-56916

(51) Int. Cl. G02F 1/1335; H05B 37/02

(52) U.S. Cl. 349/61; 315/294

(57) ABSTRACT

In a method of driving a light source, initial driving signals are applied to a plurality of color light sources in response to a power-on signal from an external device. During a predetermined set time period, light amount control signals for controlling an amount of light generated by the color light sources are generated using a predetermined function with reference signals and first sensing signals generating by sensing the amount of the light generated by the color light sources driven by the initial driving signals. Then, compensated driving signals, which are compensated based on the light amount control signal, are applied to the color light sources to compensate the amount of the light generated by the color light sources.

### PRIORITY STATEMENT

This application claims priority under 35 U.S.C. § 119 to Korean Patent Application No. 2008-56916, filed on Jun. 17, 2008 in the Korean Intellectual Property Office (KIPO), the contents of which are incorporated herein by reference in their entirety.

### BACKGROUND OF THE INVENTION

1. Field of the Invention

Embodiments of the present invention relate to a method of driving a light source, a backlight assembly for performing the method, and a display apparatus having the backlight assembly. More particularly, embodiments of the present invention relate to a method of driving a light source capable of compensating brightness and color coordinates of the light source, a backlight assembly for performing the method, and a display apparatus having the backlight assembly.

2. Description of the Related Art

A liquid crystal display (LCD) device generally displays an image using electrical and optical properties of liquid crystal. Because the LCD device may have properties of thin thickness, light weight, low power consumption, LCD devices are widely used.

An LCD device generally includes an LCD panel that displays the image using the electrical and optical properties of liquid crystal and a backlight assembly providing the LCD panel with light.

The backlight assembly generally includes a light source generating the light provided to the LCD panel. A cold cathode fluorescent lamp (CCFL), a flat fluorescent lamp (FFL), a light-emitting diode (LED), etc. may be largely used as the light source.

The LED may be manufactured as a chip type and have properties such as high brightness, low power consumption, etc. Thus, LEDs are widely used as the light source of a backlight assembly. Recently, in order to improve color properties, color LEDs are used as the light source. However, the color LEDs have brightness and color coordinates which change with the passage of time.

Thus, the backlight assembly using the color LEDs as the light source employs a color sensor for compensating the change of the brightness and the color coordinated with the passage of time. F or example, a conventional backlight assembly may employ the color sensor to detect light amounts of red light generated by a red LED, green light generated by a green LED and blue light generated by the blue LED in real time and to compensate the amounts of the red, green and blue light based on the detected light amount, so that the brightness and the color coordinates of the color light may be compensated.

### SUMMARY OF THE INVENTION

Embodiments of the present invention provide a method of driving a light source capable of simplifying the compensating operation of the brightness and the color coordinates of the light source.

Embodiments of the present invention also provide a backlight assembly for performing the method.

Embodiments of the present invention further provide a display apparatus having the backlight assembly.

According to one aspect of the present invention, there is provided a method of driving a light source. In the method, initial driving signals are applied to a plurality of color light sources in response to a power-on signal from an external device. During a predetermined set time period, light amount control signals for controlling an amount of light generated by the color light sources are generated using a predetermined function based on first sensing signals generating by sensing the amount of the light generated by the color light sources driven by the initial driving signals and reference signals. Then, compensated driving signals, which are compensated based on the light amount control signal, are applied to the color light sources to compensate the amount of the light generated by the color light sources.

The light amount control signals may be generated by compensating the first sensing signals to generate compensating signals and generating the light amount control signals based on the compensating signals and the reference signals.

In the method, temperature sensing signals sensing a circumference temperature may be received in response to the power-on signal. The light amount control signals may be generated using the first sensing signals and reference temperature signals corresponding to the temperature sensing signals.

In the method, the initial driving signals may be applied to the color light source in response to a power-off signal from the external device. Renewing signals for renewing the reference signals may be generated based on second sensing signals generated by sensing the amount of the light of the color light source driven by the initial driving signals and the reference signals.

In the method, the initial driving signals may be applied to the color light sources when an external control signal is received. The light amount control signals may be generated using third sensing signals generated by sensing the amount of the light of the color light sources driven by the initial driving signals and the reference signals.

In the method, the initial driving signals may be applied to the color light sources when the external control signal is received out of the predetermined set time period. During the predetermined set time period, the light amount control signals may be generated based on fourth sensing signals generated by sensing the amount of the light of the color light sources driven by the initial driving signals and the reference signals.

According to one aspect of the present invention, there is provided a backlight assembly. The backlight assembly includes a light source unit, a light sensor, and a light source driver. The light source unit may include a plurality of color light sources. The color light sources may generate color light. The light sensor may sense amounts of the color light. The light source driver may apply initial driving signals to the light source unit in response to a power-on signal from an external device. The light source driver may also generate light amount control signals for controlling the amounts of the color light, using a predetermined function based on first sensing signals generated by the light sensor and reference signals. The first sensing signals may be generated by sensing the amount of the color light during a predetermined set time period. The light source driver may further compensate the amount of the color light generated by the color light sources.

According to one aspect of the present invention, there is provided a display apparatus. The display apparatus includes a display panel, a light source unit, a light sensor, and a light source driver. The display panel may display an image. The light source unit may include a plurality of color light sources generating color light and provide the display panel with the color light. The light sensor may sense amounts of the color light. The light source driver may apply initial driving signals to the light source unit in response to a power-on signal from an external device. The light source driver may also generate light amount control signals for controlling the amounts of the color light, using a predetermined function based on first sensing signals generated by the light sensor and reference signals. The first sensing signals may be generated by sensing the amount of the color light during a predetermined set time period. The light source driver may further compensate the amount of the color light generated by the color light sources.

According to example embodiments of the present invention, brightness and color coordinates may be compensated only during a set time period. A light sensor may operate only during an initial time period of the set time period. An amount of light is controlled based on sensing signals generated by the light sensor and reference signals so that the brightness and the color coordinates of light sources may be compensated. Therefore, the compensating operation of the light sources may be simplified.

### BRIEF DESCRIPTION OF THE DRAWINGS

The above and other features and advantages of the present invention will become readily apparent by reference to the following detailed description when considered in conjunction with the accompanying drawings wherein:

FIG. 1 is a block diagram illustrating a display apparatus in accordance with example embodiments of the present invention;

FIGS. 2A and 2B are graphs illustrating the brightness and the color coordinates of color light versus time, respectively;

FIG. 3 is a graph illustrating a duty change of the color light versus time;

FIGS. 4A to 4C are a flowchart illustrating a method of driving a light source in accordance with example embodiments of the present invention;

FIG. 5 is a flowchart illustrating a method of driving a light source in accordance with example embodiments of the present invention;

FIG. 6 is a block diagram illustrating a display apparatus in accordance with example embodiments of the present invention; and

FIGS. 7A and 7B are a flowchart illustrating a method of driving a light source in accordance with example embodiments of the present invention.

### DETAILED DESCRIPTION OF THE INVENTION

The present invention is described more fully hereinafter with reference to the accompanying drawings, in which example embodiments of the present invention are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments of the invention are described herein with reference to cross-sectional illustrations that are schematic illustrations of idealized example embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

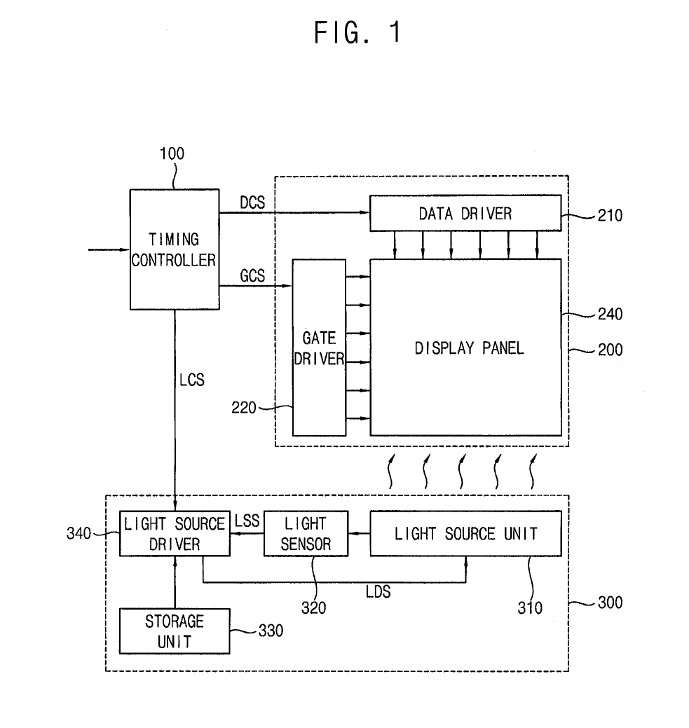

FIG. 1 is a block diagram illustrating a display apparatus in accordance with example embodiments of the present invention.

Referring to FIG. 1, a display apparatus includes a timing controller 100, a display assembly 200 and a backlight assembly 300.

The timing controller 100 receives an image signal, an image control signal and a light source control signal from an external device, such as a graphic controller, to control the drive of the display apparatus. The image control signal may include a data control signal DCS and a gate control signal GCS.

The display assembly 200 displays an image using the image control signal DCS and GCS which are applied from the timing controller 100 and the light which is provided by the backlight assembly 300. The display assembly 200 may include a data driver 210, a gate driver 220 and a display panel 240.

The data driver 210 may apply a data driving signal DDS to the display panel 240 in response to the data control signal DCS received from the timing controller 100.

The gate driver 220 may apply a gate driving signal GDS to the display panel 240 in response to the gate control signal GCS.

The display panel 240 may be controlled by the data driving signal DDS and the gate driving signal GDS and display the image using the light provided by the backlight assembly 300. The display panel 240 may include an array substrate, an opposite substrate and a liquid crystal layer. The array substrate may include a plurality of switching elements such as thin-film transistors (TFTs). The opposite substrate may be opposite to the array substrate. The opposite substrate may include a color filter substrate on which color filters are arranged. The liquid crystal layer may be interposed between the array substrate and the opposite substrate.

The backlight assembly 300 may provide the display assembly 200 with the light in response to the light source control signal LCS received from the timing controller 100. The light source control signal LCS may include a power-on signal, a power-off signal and an external control signal. The external control signal may be a control signal for changing the image displayed by the display panel. For example, the external control signal may include a channel-changing signal.

The backlight assembly 300 may include a light source unit 310, a light sensor 320, a storage unit 330, and a light source driver 340.

The light source unit 310 may generate the light based on driving signals LDS provided by the light source driver 340. The light source unit 310 may include a plurality of light sources generating color light. For example, the light source unit 310 may include a red light-emitting diode (LED), a green LED and a blue LED.

The light sensor 320 may be controlled by the light source driver 340 to sense the amount of the color light generated by the light sources. The light sensor 320 may generate a sensing signal LSS based on the amount of the color light and provide the light source driver 340 with the sensing signal LSS.

The storage unit 330 may store a plurality of reference signals for compensating the amount of the color light generated by the light sources. The reference signals may include an analog/digital converting (ADC) value and a duty value which correspond to a target brightness value and a target color coordinate value. The ADC value may be an output value of the light sensor 320. Initial reference signals stored in the storage unit 330 may be attained by testing during manufacturing processes and may be renewed by a renewing signal from the light source driver 340.

In addition, the storage unit 330 may further store the information concerning the set time period during which the amount of the color light generated by the light sources is compensated.

It is noted that all connections between elements of FIG. 1 may not be illustrated.

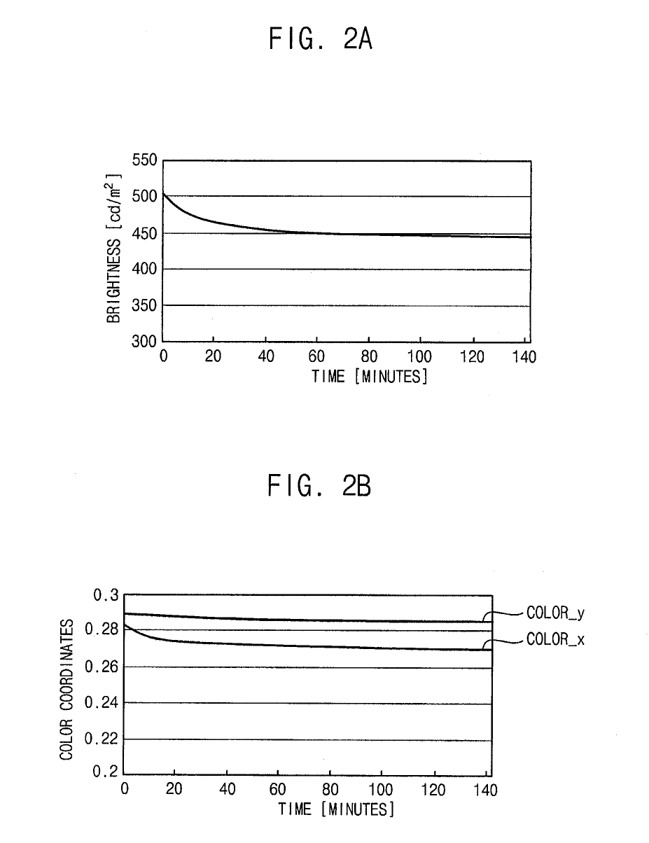

FIGS. 2A and 2B are graphs illustrating the brightness and the color coordinates of color light versus time.

Referring to FIGS. 2A and 2B, the color coordinates and the brightness is greatly changed during an initial time period, for example a time period of about zero minutes to about thirty minutes. Also, after a time period of about zero minutes to about sixty minutes, the color coordinates and the brightness may be nearly constant. Thus, the set time period may be determined considering the changes of the color coordinates and the brightness of the light sources versus time. The set time period may be changed according to machinery properties of the light source unit 310.

The light source driver 340 may control the light source unit 310, the light sensor 320 and the storage unit 330 based on the light source control signal LCS received from the timing controller 100.

The light source driver 340 may compensate the changes of the brightness and the color coordinates of the light sources in response to the power-on signal, the power-off signal and/or the external control signal. The light source driver 340 may compensate the amount of the color light generated by the light sources to compensate the brightness and the color coordinates of the light sources. The amount of the color light may be compensated by adjusting the duty of the driving signals applied to the light sources.

When the light source driver 340 receives the power-on signal, the light source driver 340 may apply initial driving signals to the light source unit 310. The initial driving signals may include signals for driving the light sources in a full white grayscale or a middle grayscale. When the light source driver 340 applies the initial driving signals to the light sources, the light sources generate light and the light sensor 320 senses the light generated by the light source to generate first sensing signals. When the light source driver 340 receives the first sensing signals from the light sensor 320, the light source driver 340 may generate light amount control signals during the set time period. The light amount control signals may control the amount of the light generated by the light source, and may be generated using the first sensing signals and a predetermined function based on the reference signals. The predetermined function may be a linear function or a nonlinear function.

According to time at which the power-off signal is applied to the light source driver 340, the backlight assembly 300 may operate as follows. When the light source driver 340 receives the power-off signal in the set time period, the light source driver 340 may not apply the initial driving signals to the light source unit 310.

When the light source driver 340 receives the power-off signal out of the set time period, the light source driver 340 applies the initial driving signals to the light source unit 310. Then, the light source unit 310 generates light in response to the initial driving signals from the light source driver 340, and the light sensor 320 senses the light to generate second sensing signals. The light source driver 340 may generate renewing signals for renewing the reference signals based on the second sensing signals and the reference signals and provide the storing part 330 with the renewing signals. The renewing signals may renew the reference signals stored in the storage unit 330. The reason for renewing the reference signals is because the reference signals corresponding to the target brightness and the target color coordinates may be changed by a change of the properties of the light sources with the passage of time.

Table 1 illustrates examples of the reference signals stored in the storage unit 330 and the sensing signals for generating the light amount controlling signals.

TABLE 1

| | | DUTY CYCLE | | | | |
|---|---|---|---|---|---|---|
| | | INITIAL | FIRST | FIRST | SECOND | SECOND |
| LIGHT | | REFERENCE | POWER-ON | POWER-OFF | POWER-ON | POWER-OFF |
| SOURCE | ADC | VALUE | SIGNAL | SIGNAL | SIGNAL | SIGNAL |
| RED | 8000 | 82% | 80% | 82.1% | 80.2% | 82.1% |
| GREEN | 9000 | 91% | 90% | 91.1% | 91.2% | 91.1% |
| BLUE | 7000 | 61% | 60% | 61.1% | 61.2% | 61.1% |

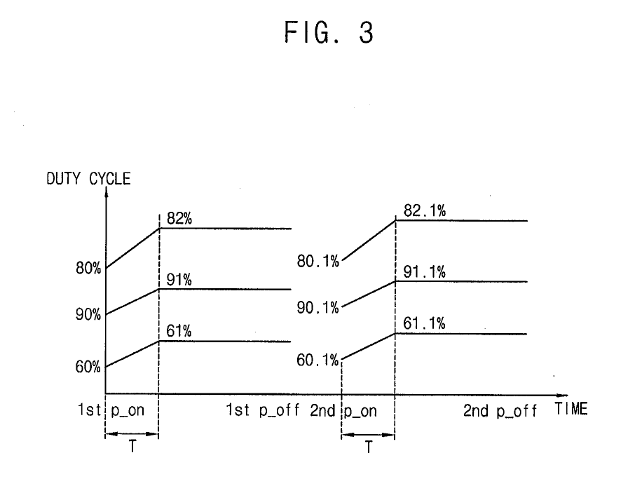

FIG. 3 is a graph illustrating a duty change of the color light versus time. FIG. 3 illustrates Table 1.

Referring to FIG. 1 and Table 1, when the light source driver 340 receives the power-on signal or the power-off signal, the backlight assembly may operate as follows.

For example, the light source driver 340 may apply the initial driving signals to the light source unit 310 having red, green and blue light sources in response to a first power-on signal, and the red, green and blue light sources respectively generate red light, green light and blue light in response to the initial driving signals. The light sensor 320 senses the red light, the green light and the blue light to generate first sensing signals. Duty cycles of the first sensing signals may be about 80%, about 90%, and about 60%, respectively. The storage unit 330 may store the duty cycles of the sensing signals in a lookup table form. The storage unit 330 may provide the light source driver 340 with the duty cycles of the sensing signals of the light sensor 320 according to requests from the light source driver 340.

The light source driver 340 may generate the light amount control signals during the set time period T. The light amount control signals may be generated using the predetermined function based on the duty cycles of the first sensing signals of about 80%, about 90% and about 60% and the duty cycles of the initial reference signals of about 82%, about 91% and about 61%.

The light source driver 340 may provide the color light sources with compensated driving signals by the light amount control signal to compensate the amount of the light generated by the color light sources. Thus, as illustrated in FIG. 3, during the set time period T, the duty cycles of the first sensing signals of about 80%, about 90% and about 60% may be increased to be substantially the same as the duty cycles of the reference signals of about 82%, about 91% and about 61%.

While the backlight assembly 300 is driven in a general driving operation after the set time period, the light source driver 340 may block the compensated driving signal and apply the initial driving signal to the color light sources, when the light source driver 340 receives the first power-off signal. During the general driving operation of the backlight assembly 300, the amount of the light generated by the color light is not compensated and driving signals according to the light source control signal received from the timing controller 100 are applied to the light source unit 310. The light source driver 340 generates the renewing signals based on the second sensing signals corresponding to the initial driving signals and the reference signals. When the duty cycles of the renewing signals generated in response to the first power-off signal are about 82.1%, about 91.1% and about 61.1%, the duty cycles of the reference signals of about 82%, about 91% and about 61% stored in the storage unit 330 are renewed to be substantially the same as the duty cycles of the renewing signals of about 82.1%, about 91.1% and about 61.1%.

For example, the light source driver 340 provides the initial driving signals to the color light sources in response to the second power-on signal. The color light source generates color light in response to the initial driving signals. The light sensor 320 senses the color light to generate third sensing signals. Duty cycles of the third sensing signals may be about 80.1%, about 91% and about 60.1%, respectively. The light source driver 340 may generate the light amount control signal during the set time period T. The light amount control signal may be generated based on the duty cycles of the third sensing signals of about 80.1%, about 91% and about 60.1% and the duty cycles of the reference signals of about 82.1%, about 91.1% and about 61.1%. The light source driver 340 may provide the color light sources with compensated driving signals by the light amount control signal to compensate the amount of light generated by the color light source. Thus, as illustrated in FIG. 3, the duty cycles of the third sensing signals may be increased to be substantially the same as the duty cycles of the reference signals of about 82.1%, about 91.1% and about 61.1%.

While the backlight assembly 300 is driven in the general driving operation after the set time period, the light source driver 340 may apply the initial driving signal to the color light sources, the color light sources generate color light in response to the initial driving signals and the light sensor 320 senses the color light generated by the color light source to generate the fourth sensing signals, when the light source driver 340 receives the second power-off signal. The light source driver 340 generates the renewing signals based on the fourth sensing signals and the reference signals. When the duty cycles of the renewing signals generated in response to the second power-off signal are about 82.2%, about 91.2% and 61.2%, the duty cycles of the reference signals of about 82.1%, about 91.1% and about 61.1% are renewed to be substantially the same as the duty cycles of the renewing signals of about 82.2%, about 91.2% and about 61.2%.

When the light source driver 340 receives the external control signal, the backlight may operate as follows. When the light source driver 340 receives the external control signal in the set time period, the light source driver 340 may apply the initial driving signal to the light source unit 310. Then, the light source unit 310 generates light in response to the initial driving signals and the light sensor 320 senses the light to generate sensing signals. The light source driver 340 may generate the light amount control signal based on the sensing signals and the reference signals. That is, the light source driver 340 may generate the light amount control signal using the sensing signals newly generated by the light sensor 320 from a time point at which the light source driver 340 receives an end time of the set time period.

When the light source driver 340 receives the external control signal out of the set time period, the light source driver 340 applies the initial driving signals to the light source unit 310, the light source unit 310 generates light in response to the initial driving signals, and the light sensor 320 senses the light to generate the sensing signals. The light source driver 340 may generate the light amount control signal based on the sensing signals and the reference signals.

The light source driver 340 may compensate the driving applied to the color light sources based on the light amount control signal and provide the color light sources with the compensated driving signal to compensate the amount of the light generated by the color light source. The light source driver 340 may control the duty cycles of the driving signals applied to the color light sources based on the light amount control signal to compensate the driving signals.

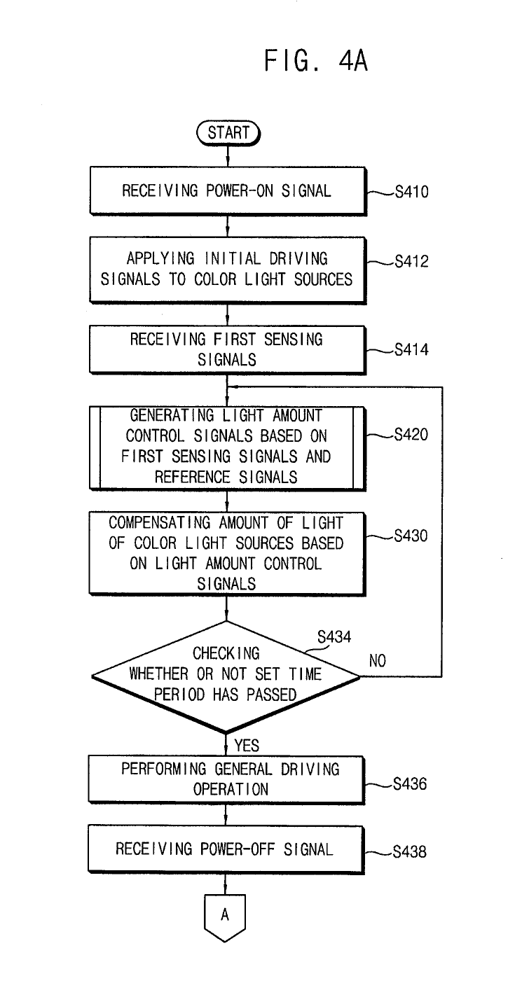

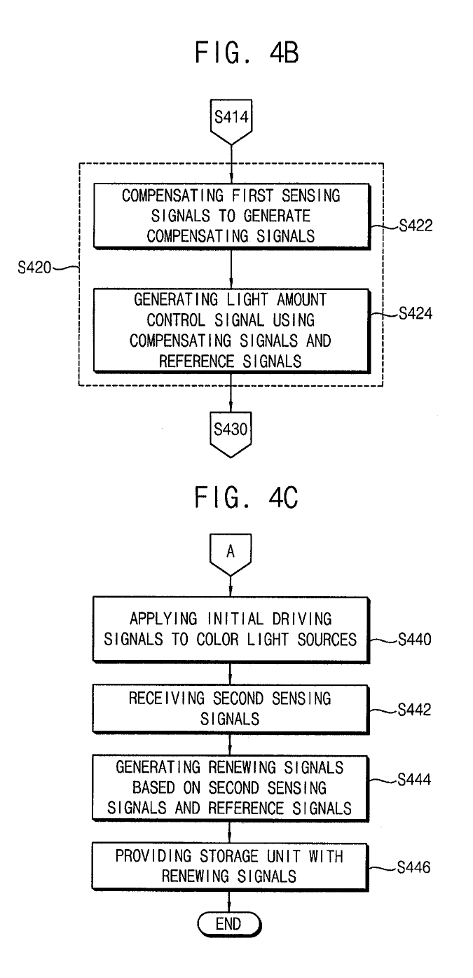

FIGS. 4A to 4C are a flowchart illustrating a method of driving a light source in accordance with example embodiments of the present invention.

Referring to FIG. 1 and FIG. 4A, when the light source driver 340 receives the power-on signal from the timing controller 100 (step S410), the light source driver 340 applies the initial driving signals to the light source unit 310 (step S412). The initial driving signals may include signals for driving the color light sources in a full-white grayscale or a middle grayscale.

When the light source driver 340 receives the first sensing signals generated corresponding to the initial driving signals from the light sensor 320 (step S414), the light source driver 340 may generate the light amount control signal for controlling the amount of the light generated by the light source unit 310, based on the first sensing signals and the reference signals (step S420).

FIG. 4B illustrates step S420 shown in FIG. 4A. Referring to FIG. 4B, the light source driver 340 may compare the first sensing signals received from the light sensor 320 with the reference signals to compensating signals to compensate the first sensing signals (step S422).

The light source driver 340 may generate the light amount control signal using a predetermined function based on the first sensing signals and reference signals (step S430). The light source driver 340 may control the duty cycles of the driving signals applied to the color light sources based on the light amount control signal to compensate the driving signals.

Then, the light source driver 340 checks whether or not the set time period has passed (step S434).

In step S434, when the light source driver 340 checks that the set time period has not passed, the light source driver 340 may return to step S420 to generate the light amount control signal and compensate the amount of the light generated by the color light source based on the light amount control signal.

In step S434, when the light source driver 340 checks that the set time period has passed, the light source driver 340 may operate in the general driving operation (step S436). During the general driving operation of the backlight assembly 300, the amount of the light generated by the color light is not compensated and driving signals according to the light source control signal received from the timing controller 100 are applied to the light source unit 310.

During the general driving operation, when the light source driver 340 receives the power-off signal from the timing controller 100 (step S438), the light source driver 340 may block the driving signals applied to the color light source and provide the color light source with the initial driving signals (S440).

Then, when the light source driver 340 receives the second sensing signals corresponding toe the initial driving signals from the light sensor 320 (step S442), the light source driver 340 may generate the renewing signals for renewing the reference signals based on the second sensing signals and the reference signals (step S444).

The light source driver 340 may provide the storage unit 330 with the renewing signals to renew the reference signals (step S446). When the renewing signals is generated, compensating signals, which may correspond to compensated second sensing signals, may be generated and the renewing signals may be generated using the compensating signals and the reference signals.

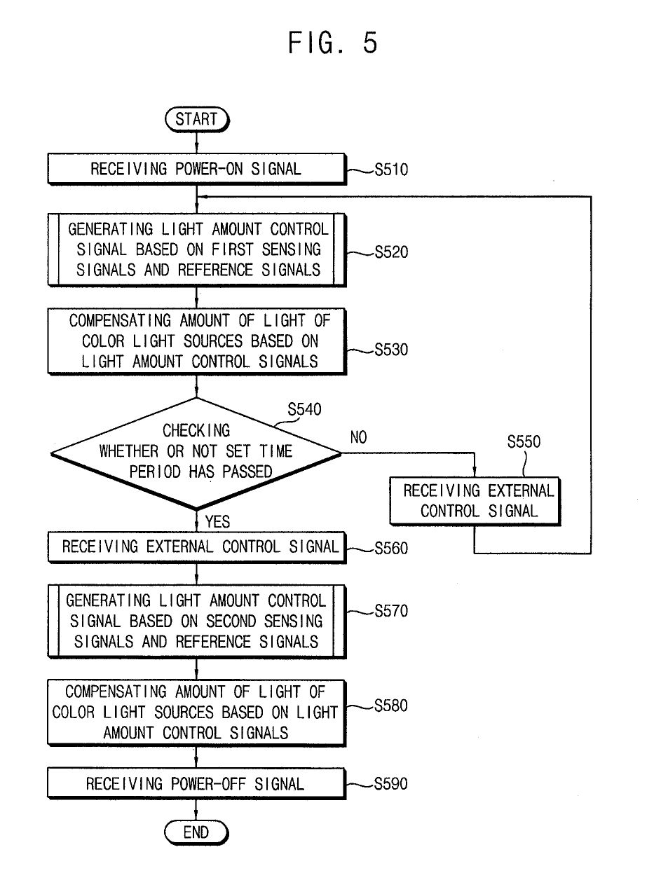

FIG. 5 is a flowchart illustrating a method of driving a light source in accordance with example embodiments of the present invention.

Referring to FIG. 1 and FIG. 5, when the light source driver 340 receives the power-on signal from the timing controller 100, the light source driver 340 may apply the initial driving signals to the light source unit 310 and generate the light amount control signal corresponding to the initial driving signals (step S520). For example, step S520 may include steps S412, S414 and S420 illustrated in FIG. 4A and the light amount control signal may be generated by sequentially performing steps S412, S414 and S420.

The light source driver 340 may apply the compensated driving signals, which are compensated based on the light amount control signal, to the color light sources to compensate the amount of the light generated by the color light source (step S530). For example, the light source driver 340 may control the duty cycles of the driving signals applied to the color light source to compensate the driving signals.

Then, the light source driver 340 checks whether or not the set time period has passed (step S540).

In step S540, when the light source driver 340 checks that the set time period has passed and the light source driver 340 receives the external control signal (step S550), the light source driver 340 may return to step S520 and repetitively perform steps S520 and S530 during the set time period.

In step S540, when the light source driver 340 checks that the set time period has not passed and the light source driver 340 receives the external control signals from the timing controller 100 (step S560), the light source driver 340 may apply the initial driving signals to the light source unit 310 and generate the light amount control signal based on the second sensing signals corresponding to the initial driving signals and the reference signals (step S570). For example, step S570 may include steps S440 and S442 illustrated in FIG. 4C, the light source driver 340 may generate the light amount control signal based on the second sensing signals generated by performing steps S440 and S442 and the reference signals.

The light source driver 340 may apply the compensated driving signals, which are compensated based on the light amount control signal, to the color light sources to compensate the amount of the light generated by the color light sources (step S580).

When the light source driver 340 receives the external control signals in the set time period, the light source driver 340 may stop the compensating operation and apply the initial driving signals to the light source unit, and the light sensor may sense the amount of the light generated by the color light sources driven by the initial driving signals. The light source driver 340 may compensate the amount of the light generated by the color light sources based on the second sensing signals and the reference signals during a time period from time at which the light source driver 340 stops the compensating operation to end time of the set time period. When the set time period has passed, the light source driver 340 may not perform the compensating operation and perform the general driving operation.

When the light source driver 340 receives the power-off signal from the timing controller 100, the light source driver 340 may block the driving signals applied to the color light sources and end the light source driving operation.

The light source driver 340 may perform steps S440 to S446 in response to the power-off signal and renew the reference signals stored in the storage unit 330 using the renewing signals generated by performing steps S440 to S446.

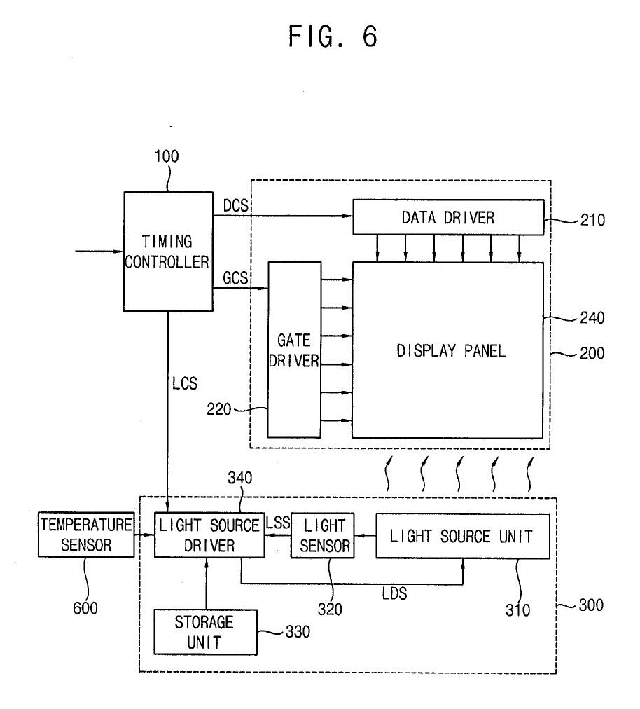

FIG. 6 is a block diagram illustrating a display apparatus in accordance with example embodiments of the present invention.

Referring to FIG. 6, a display apparatus includes a timing controller 100, a display assembly 200, a backlight assembly 300, and a temperature sensor 600. The backlight assembly 300 may include a light source unit 310, a light sensor 320, a storage unit 330, and a light source driver 340.

The display apparatus has components which are substantially the same as or substantially similar to those of the display apparatus illustrated in FIGS. 1 to 5, except for the temperature sensor 600. Thus, the same or similar component is referred using a same reference numeral and any repetitive explanation will be omitted.

The temperature sensor 600 may sense the temperature of a circumference of the display assembly 200 to generate a temperature sensing signal and provide the light source driver 340 with the temperature sensing signal.

The storage unit 330 may store reference temperature signals according to the temperature. When the light source driver 340 requests, the storage unit 330 may provide the light source driver 340 with some reference temperature signals corresponding to the temperature sensed by the temperature sensor 600.

When the light source driver 340 generates the light amount control signal in response to the power-on signal and the external control signal and the renewing signals in response to the power-off signal, the light source driver 340 may use the same reference temperature signals corresponding to the temperature sensed by the temperature sensor 600. When considering the temperature of the circumference of the display assembly 200, the brightness properties of the color light sources may be largely improved.

Although a structure in which the storage unit 330 is connected to the light source driver 340 to be directly controlled by the light source driver 340 has been described above, the storage unit 330 may be connected to the timing controller 100 to be controlled by the timing controller 100.

It is noted that all connections between elements of FIG. 6 may not be illustrated.

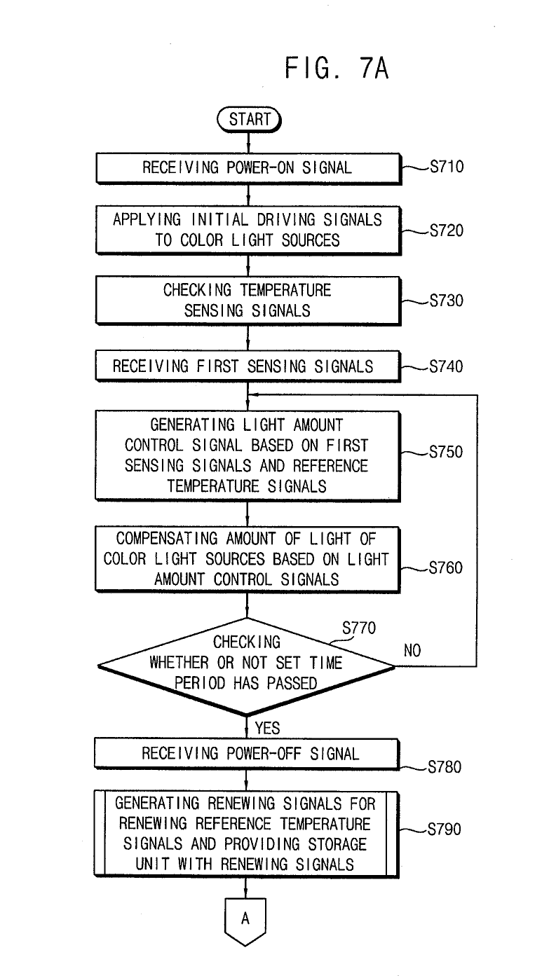

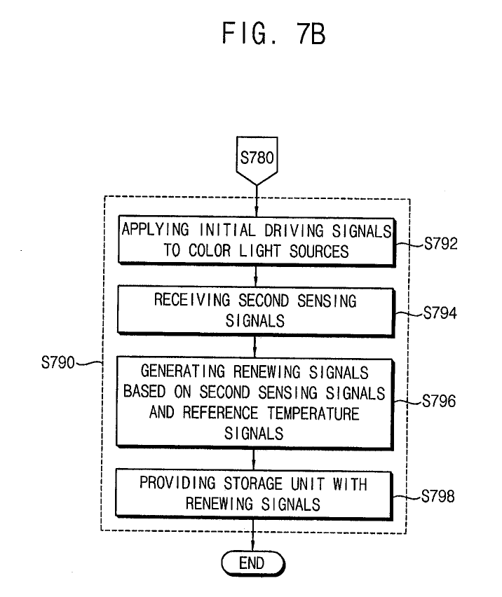

FIGS. 7A and 7B are a flowchart illustrating a method of driving a light source in accordance with example embodiments of the present invention.

Referring to FIG. 6, FIG. 7A and FIG. 7B, when the light source driver 340 receives the power-on signal from the timing controller 100 (step S710), the light source driver 340 may apply the initial driving signals to the light source unit 310 (step S720).

The light source driver 340 may check the temperature sensing signals generated by the temperature sensor 600 (step S730). Then, the light source driver 340 may provide the storage unit 330 with the temperature sensing signals to request the storage unit 330 to provide the reference temperature signals corresponding to the temperature sensing signals.

When the light source driver 340 receives the first sensing signals corresponding to the initial driving signals (step S740), the light source driver may generate the light amount control signal based on the second sensing signals from the light sensor 320 and the reference temperature signals corresponding to the temperature sensing signals from the temperature sensor 600 (step S750).

The light source driver 340 may apply the compensated driving signals, which are compensated based on the light amount control signal, to the color light sources to compensate the amount of the light generated by the color light sources (step S760). The light source driver 340 may control the duty cycles of the driving signals applied to the color light sources based on the light amount control signal to compensate the driving signals.

Then, the light source driver 340 may check whether or not the set time period has passed (step S770).

In step S770, when the light source driver 340 has determined that the set time period has not passed, the light source driver 340 may return to step S750 to generate the light amount control signal and to control the driving signals based on the light amount control signal to provide the color light source with the compensated driving signals.

In step S770, when the light source driver 340 determines that the set time period has passed and receives the power-off signal from the timing controller 100 (step S780), the light source driver 340 may generate the renewing signals for renewing the reference temperature signals corresponding to the temperature sensing signals and provide the storage unit 330 with the renewing signals (step S790).

For example, the light source driver 340 may block the driving signals applied to the color light source and provide the color light sources with the initial driving signals again (step S792).

When the light source driver 340 receives the second sensing signals corresponding to the initial driving signals from the light sensor 320 (step S794), the light source driver 340 may generate the renewing signals based on the second sensing signals and the reference temperature signals corresponding to the temperature sensing signals.

The light source driver 340 may provide the storage unit 330 with the renewing signals to renew the reference temperature signals corresponding to the temperature sensing signals using the renewing signals (step S798). When generating the renewing signals, the second sensing signals may be compensated to generate the compensating signals and the renewing signals may be generated based on the compensating signals and the reference temperature signals corresponding to the temperature sensing signals.

According to example embodiments of the present invention, brightness and color coordinates may be compensated only during a set time period when a light source driver receives a power-on signal and/or an external control signal. A light sensor may operate only during an initial time period of the set time period, and then the light source driver may generate a light amount control signal using a predetermined function based on sensing signals generated by the light sensor and reference signals stored in a storage unit. The light sensor controls the amount of the light generated by a light source unit to compensate the brightness of the color coordinates of the light sources. Therefore, the compensating operation of the light sources may be simplified. Since the light sensor is not always operated, color mixing of the light entering the light sensor may be prevented and the light sensor may be prevented from erroneously detecting the amount of the light.

According to example embodiments of the present invention, when a backlight assembly performs color dimming in which light-emitting blocks may be controlled to have different colors from each other, the brightness and the color coordinates of the light sources may be easily compensated without a special algorithm.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of this invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. A method of driving a light source, comprising:
applying initial driving signals to a plurality of color light sources in response to a power-on signal from an external device;
during a predetermined set time period, generating light amount control signals for controlling an amount of light generated by the color light sources using a predetermined function with reference signals and first sensing signals generated by sensing the amount of light generated by the color light sources driven by the initial driving signals; and
applying compensated driving signals, which are compensated based on the light amount control signals, to the color light sources to compensate the amount of light generated by the color light sources.

2. The method of claim 1, wherein generating the light amount control signals comprises:
compensating the first sensing signals to generate compensating signals; and
generating the light amount control signals based on the compensating signals and the reference signals.

3. The method of claim 1, further comprising receiving temperature sensing signals sensing a circumference temperature in response to the power-on signal,
wherein generating the light amount control signals comprises using the first sensing signals and reference temperature signals corresponding to the temperature sensing signals to generate the light amount control signals.

4. The method of claim 1, further comprising:
applying the initial driving signals to the color light sources in response to a power-off signal from the external device; and
generating renewing signals for renewing the reference signals based on the reference signals and second sensing signals generated by sensing the amount of the light of the color light sources driven by the initial driving signals.

5. The method of claim 4, further comprising blocking driving signals applied to the color light sources when the power-off signal is inputted in the predetermined set time period.

6. The method of claim 1, further comprising applying the initial driving signals to the color light sources when an external control signal is received,
wherein generating the light amount control signals comprises using the reference signals and third sensing signals generated by sensing the amount of the light of the color light sources driven by the initial driving signals.

7. The method of claim 6, further comprising:
applying the initial driving signals to the color light sources when the external control signal is received out of the predetermined set time period; and
during the predetermined set time period, generating the light amount control signals based on the reference signals and fourth sensing signals generated by sensing the amount of the light of the color light sources driven by the initial driving signals.

8. The method of claim 1, wherein the initial driving signals comprise signals for driving the color light sources in a full-white grayscale or a middle grayscale, and the reference signals comprise target brightness values and color coordinate values of color light generated by the color light sources.

9. A backlight assembly comprising:
a light source unit comprising a plurality of color light sources for generating color light;
a light sensor for sensing amounts of the generated color light; and
a light source driver applying initial driving signals to the light source unit in response to a power-on signal from an external device, generating light amount control signals for controlling the amounts of the color light using a predetermined function with reference signals and first sensing signals generated by the light sensor, the first sensing signals being generated by sensing the amount of the color light during a predetermined set time period, and compensating the amount of the color light generated by the color light sources.

10. The backlight assembly of claim 9, further comprising:
a temperature sensor sensing a circumference temperature to generate temperature sensing signals; and
a storage unit storing a plurality of reference temperature signals and providing the light source driver with some of the reference temperature signals corresponding to the circumference temperature according to a request from the light source driver.

11. The backlight assembly of claim 9, wherein the light source driver applies the initial driving signals to the light source unit in response to a power-off signal from an external device, generates renewing signals for renewing the reference signals based on the reference signals and second sensing signals generated by the light sensor, the second sensing signals being generated by sensing the amount of color light of the color light sources driven by the initial driving signals, and provides the storage unit with the renewing signals.

12. The backlight assembly of claim 11, wherein the light source driver blocks driving signals applied to the light source unit when the light source driver receives the power-off signal in the predetermined set time period.

13. The backlight assembly of claim 9, wherein the light source driver applies the initial driving signals to the light source unit and generates the light amount control signals based on the reference signals and third sensing signals generated by the light sensor, the third sensing signals being generated by sensing the amount of color light of the color light sources driven by the initial driving signals, when the light source driver receives an external control signal in the predetermined set time period.

14. The backlight assembly of claim 13, wherein the light source driver applies the initial driving signals to the light source unit and generates the light amount control signals based on the reference signals and fourth sensing signals generated by the light sensor, the fourth sensing signals being generated by sensing the amount of color light of the color light sources driven by the initial driving signals during the predetermined time period, when the light source driver receives the external control signal out of the predetermined set time period.

15. A display apparatus comprising:
a display panel for displaying an image;
a light source unit comprising a plurality of color light sources for generating color light and providing the display panel with the color light;
a light sensor for sensing amounts of the color light; and
a light source driver applying initial driving signals to the light source unit in response to a power-on signal from an external device, generating light amount control signals for controlling the amounts of the color light using a predetermined function with reference signals and first sensing signals generated by the light sensor, the first sensing signals being generated by sensing the amount of the color light during a predetermined set time period, and compensating the amount of the color light generated by the color light sources.

16. The display apparatus of claim 15, further comprising:
a temperature sensor sensing a circumference temperature to generate temperature sensing signals; and
a storage unit storing a plurality of reference temperature signals and providing the light source driver with some of the reference temperature signals corresponding to the circumference temperature according to a request from the light source driver.

17. The display apparatus of claim 15, wherein the light source driver applies the initial driving signals to the light source unit in response to a power-off signal from an external device, generates renewing signals for renewing the reference signals based on the reference signals and second sensing signals generated by the light sensor, the second sensing signals being generated by sensing the amount of color light of the color light sources driven by the initial driving signals, and provides the storage unit with the renewing signals.

18. The display apparatus of claim 15, wherein the light source driver blocks driving signals applied to the light source unit when the light source driver receives the power-off signal in the predetermined set time period.

19. The display apparatus of claim 15, wherein the light source driver applies the initial driving signals to the light source unit and generates the light amount control signals based on the reference signals and third sensing signals generated by the light sensor, the third sensing signals being generated by sensing the amount of color light of the color light sources driven by the initial driving signals, when the light source driver receives an external control signal in the predetermined set time period

20. The display apparatus of claim 15, wherein the light source driver applies the initial driving signals to the light source unit and generates the light amount control signals based on the reference signals and fourth sensing signals generated by the light sensor, the fourth sensing signals being generated by sensing the amount of color light of the color light sources driven by the initial driving signals during the predetermined time period, when the light source driver receives the external control signal out of the predetermined set time period.
